(19) United States
(12) Patent Application Publication
(10) Pub. No.: US 2025/0122381 A1
(43) Pub. Date: Apr. 17, 2025

(54) SIZING AGENT FOR INORGANIC FIBERS, INORGANIC FIBERS, METHOD FOR PRODUCING SAME, AND COMPOSITE MATERIAL

(71) Applicant: TAKEMOTO YUSHI KABUSHIKI KAISHA, Aichi-ken (JP)

(72) Inventors: Jun Ito, Gamagori-shi (JP); Takuya Matsunaga, Gamagori-shi (JP); Keiichiro Oshima, Gamagori-shi (JP)

(73) Assignee: TAKEMOTO YUSHI KABUSHIKI KAISHA, Aichi-ken (JP)

(21) Appl. No.: 18/567,579

(22) PCT Filed: Jun. 9, 2022
(86) PCT No.: PCT/JP2022/023294

§ 371 Date: Dec. 6, 2023

(30) Foreign Application Priority Data
Jun. 11, 2021 (JP) 2021-097769

(51) Int. Cl. C09C 3/10; C08K 9/04

(52) U.S. Cl. CPC C09C 3/10; C08K 9/04

(57) ABSTRACT

Disclosed is an inorganic fiber sizing agent containing a resin and cellulose nanofibers. The cellulose nanofibers are contained in a nonvolatile content of the sizing agent in an amount of 10 ppm or more and less than 50000 ppm.

### TECHNICAL FIELD

The present invention relates to an inorganic fiber sizing agent containing cellulose nanofibers, an inorganic fiber, a method for producing the same, and a composite material.

### BACKGROUND ART

Fiber-reinforced thermoplastic resin composite materials are generally known as materials containing inorganic fibers, such as carbon fibers, and a matrix resin, such as a thermoplastic resin, which is a base material, and are widely used in various fields of, for example, building materials and transportation equipment. In order to improve adhesiveness of the interface between inorganic fibers, such as carbon fibers, and a base material, such as a thermoplastic resin, a process of attaching a sizing agent to the inorganic fibers is performed.

For example, a known inorganic fiber sizing agent used for reinforcing a thermoplastic matrix resin is disclosed in Patent Document. Patent Document 1 discloses a sizing agent-coated carbon fiber obtained by coating a carbon fiber with a sizing agent containing nanocellulose having a number average fiber diameter of 1 to 1000 nm and a compound having an epoxy group. It is described that the nanocellulose is contained in the sizing agent in an amount of 5% by mass or more with respect to the total amount of the sizing agent.

### CITATION LIST

### Patent Literature

Patent Literature 1: Japanese Laid-Open Patent Publication No. 2017-119936

### SUMMARY OF INVENTION

### Technical Problem

However, the sizing agent of Patent Document 1 has a problem that the improvement of adhesiveness of the inorganic fiber to the base material is not sufficient, and a falling prevention property from the inorganic fiber and a handling property are also insufficient.

### Solution to Problem

As a result of research to solve the above problems, the inventors of the present invention have found that an inorganic fiber sizing agent containing a predetermined amount of cellulose nanofibers and a resin is very suitable.

In order to solve the above problems, an inorganic fiber sizing agent according to an aspect of the present invention contains a resin and cellulose nanofibers, and the cellulose nanofibers are contained in a nonvolatile content of the sizing agent in an amount of 10 ppm or more and less than 50000 ppm.

In the inorganic fiber sizing agent, the cellulose nanofibers may contain cellulose nanofibers with a fiber diameter of 1 nm or more and 1000 nm or less. That is, at least a part of the cellulose nanofibers may have a fiber diameter of 1 nm or more and 1000 nm or less.

In the inorganic fiber sizing agent, the resin may contain at least one selected from the group consisting of an epoxy resin, a vinyl ester resin, a polyamide resin, a polyolefin resin, a polyurethane resin, a polyester resin, a phenoxy resin, a polyimide resin, and a polyimide resin precursor.

The inorganic fiber sizing agent may further contain a surfactant.

The inorganic fiber sizing agent may be applied to a glass fiber or a carbon fiber.

The resin in the inorganic fiber sizing agent may contain at least one selected from the group consisting of an epoxy resin and a polyester resin, and in this case, the inorganic fiber sizing agent may be applied to a composite material in which a matrix resin is an epoxy resin, more specifically, to an inorganic fiber forming a part of such a composite material.

The resin in the inorganic fiber sizing agent may contain at least one selected from the group consisting of a polyamide resin, a polyurethane resin, a polyimide resin, and a polyimide resin precursor, and in this case, the inorganic fiber sizing agent may be applied to a composite material in which a matrix resin is a polyamide resin, more specifically, to an inorganic fiber forming a part of such a composite material.

The resin in the inorganic fiber sizing agent may contain a vinyl ester resin, and in this case, the inorganic fiber sizing agent may be applied to a composite material in which a matrix resin is a vinyl ester resin, more specifically, to an inorganic fiber forming a part of such a composite material.

The resin in the inorganic fiber sizing agent may contain at least one selected from the group consisting of a polyolefin resin and a phenoxy resin, and in this case, the inorganic fiber sizing agent may be applied to a composite material in which a matrix resin is a polyolefin resin, more specifically, to an inorganic fiber forming a part of such a composite material.

In order to solve the above problems, an inorganic fiber according to another aspect of the present invention has the inorganic fiber sizing agent attached thereto.

In order to solve the above problems, a method for producing an inorganic fiber according to another aspect of the present invention includes attaching the inorganic fiber sizing agent to an inorganic fiber.

In order to solve the above problems, a composite material according to another aspect of the present invention contains the inorganic fiber and a matrix resin, the resin in the inorganic fiber sizing agent contains at least one selected from the group consisting of an epoxy resin and a polyester resin, and the matrix resin is an epoxy resin.

In order to solve the above problems, a composite material according to another aspect of the present invention contains the inorganic fiber and a matrix resin, the resin in the inorganic fiber sizing agent contains at least one selected from the group consisting of a polyamide resin, a polyurethane resin, a polyimide resin, and a polyimide resin precursor, and the matrix resin is a polyamide resin.

In order to solve the above problems, a composite material according to another aspect of the present invention contains the inorganic fiber and a matrix resin, the resin in the inorganic fiber sizing agent contains a vinyl ester resin, and the matrix resin is a vinyl ester resin.

In order to solve the above problems, a composite material according to another aspect of the present invention contains the inorganic fiber and a matrix resin, the resin in the inorganic fiber sizing agent contains at least one selected from the group consisting of a polyolefin resin and a phenoxy resin, and the matrix resin is a polyolefin resin.

### Advantageous Effects of Invention

The present invention succeeds in improving adhesiveness of an inorganic fiber to a base material of a composite material, a falling prevention property from the inorganic fiber, and a handling property of a sizing agent.

### BRIEF DESCRIPTION OF DRAWINGS

FIG. 1 is a schematic view of a composite material interface characteristic evaluation apparatus for evaluating adhesiveness in the Examples section.

### DESCRIPTION OF EMBODIMENTS

### First Embodiment

First, a first embodiment in which an inorganic fiber sizing agent (also referred to hereinafter as sizing agent) according to the present invention is embodied will be described. The sizing agent contains a predetermined amount of cellulose nanofibers and a resin.

### (Cellulose Nanofibers)

The cellulose nanofibers can improve adhesiveness between an inorganic fiber and a matrix resin. The cellulose nanofibers can be classified into cellulose microfibrils (single cellulose nanofibers) with a width of 3 to 4 nm as a basic fiber diameter, cellulose microfibril bundles with a width of 10 to 20 nm obtained by bundling several cellulose microfibrils, microfibrillated cellulose forming a cobweb-shaped network with a width of several ten to several hundred nanometers obtained by further collecting microfibril bundles, and the like depending on the size, but any of them may be used. The cellulose nanofibers may be obtained by defibration and micronization using a plant-based fiber material, such as wood pulp, as a raw material by a known production method, or a commercially available product may be used. The known production method is not particularly limited, and examples thereof include a method of pulverizing by a machine, such as a high-pressure homogenizer method or an ultrasonic defibration method, an underwater counter collision method, a TEMPO oxidation method, and a method of micronizing by an enzyme such as cellulase.

The lower limit of the fiber diameter of the cellulose nanofiber is preferably 1 nm or more, and more preferably 3 nm or more. The upper limit of the fiber diameter of the cellulose nanofiber is preferably 1000 nm or less, and preferably 800 nm or less. By defining the fiber diameter within such a range, the adhesiveness between the inorganic fiber and the matrix resin can be further improved. In addition, dispersibility when prepared into a solution can be improved. The fiber diameter of the cellulose nanofiber was measured using a scanning electron microscope (SEM). First, an aqueous dispersion of cellulose nanofibers dried at 105° C. for 2 hours was enlarged to a magnification at which a fiber diameter as a fiber width can be measured by SEM. Twenty non-overlapping cellulose nanofibers were randomly selected, and their fiber diameters were determined. The maximum value and the minimum value of the obtained fiber diameters are referred to as “fiber diameter (minimum-maximum)” of the measured cellulose nanofibers. In addition, the average value of the obtained fiber diameters is referred to as “fiber diameter (average value)” of the measured cellulose nanofibers. When the cellulose nanofiber was a powder, the cellulose nanofiber was once dispersed in water and made uniform, and used.

The sizing agent preferably contains cellulose nanofibers with a fiber diameter of 1 nm or more and 1000 nm or less, more preferably contains the cellulose nanofibers in an amount of 50% by mass or more, and still more preferably contains the cellulose nanofibers in an amount of 80% by mass or more of all cellulose nanofibers.

These cellulose nanofibers may be used singly or in combination of two or more kinds thereof.

The lower limit of the content ratio of the cellulose nanofibers in the nonvolatile content of the sizing agent is 10 ppm or more, and preferably 15 ppm or more. When the content ratio is 10 ppm or more, the adhesiveness between the matrix resin and the inorganic fiber can be further improved. Also, the upper limit of the content is less than 50000 ppm, and preferably 46000 ppm or less. When the content ratio is less than 50000 ppm, handling property can be improved. The term nonvolatile content as used herein refers to a residue after a volatile substance is sufficiently removed by heat treating an object at 105° C. for 2 hours, that is, to absolutely dry matter.

### (Resin)

The resin is appropriately selected from known resins according to the use of the inorganic fiber to which the sizing agent is applied. Specific examples of the resin include an epoxy resin, a vinyl ester resin, a polyamide resin, a polyolefin resin, a polyurethane resin, a polycarbonate resin, a polyester resin, a PEEK resin, a fluororesin, a phenoxy resin, a phenol resin, a BMI resin, a polyimide resin, a polyimide resin precursor, and a polyethersulfone resin. Among them, an epoxy resin, a vinyl ester resin, a polyamide resin, a polyolefin resin, a polyurethane resin, a polyester resin, a phenoxy resin, a polyimide resin, and a polyimide resin precursor are preferable.

Specific examples of the resin further include, for example, an epoxy resin (manufactured by Mitsubishi Chemical Corporation: trade name jER828, jER1002), an epoxy resin (manufactured by Nagase ChemteX Corporation: trade name Denacol EX-521), a polyurethane resin (manufactured by DKS Co. Ltd.: trade name SUPERFLEX 500M), a modified polypropylene resin (manufactured by Maruyoshi Chemical Co., Ltd.: trade name MGP-1650), a modified polypropylene resin (manufactured by TOHO Chemical Industry Co., Ltd.: trade name Hitech P-9018), a modified polyester resin (manufactured by Toyobo Co., Ltd.: trade name Vylonal MD-1480), a phenoxy resin (manufactured by Nippon Steel Chemical & Materials Co., Ltd.: trade name YP-50S), a polyimide resin precursor of 3,3′,4,4′-biphenyltetracarboxylic anhydride and diaminodiphenyl ether, a polyamide resin (manufactured by Toray Industries, Inc.: trade name AQ Nylon P-95), a polyester resin of ethylene oxide 2-mol adduct of bisphenol A and fumaric acid, and a vinyl ester resin of an epoxy resin and methacrylic acid.

When the sizing agent is used for application to inorganic fibers forming a part of a composite material having a matrix resin as a base material, the type of the resin to be blended in the sizing agent is preferably selected in consideration of the type of the matrix resin from the viewpoint of, for example, improving the adhesiveness of the inorganic fiber to the matrix resin and improving recyclability. When the matrix resin is an epoxy resin, the resin in the sizing agent is preferably at least one selected from an epoxy resin and a polyester resin. When the matrix resin is a polyamide resin, the resin in the sizing agent is preferably at least one selected from a polyamide resin, a polyurethane resin, a polyimide resin, and a polyimide resin precursor. When the matrix resin is a vinyl ester resin, the resin in the sizing agent is preferably a vinyl ester resin. When the matrix resin is a polyolefin resin, the resin in the sizing agent is preferably at least one selected from a polyolefin resin and a phenoxy resin.

### (Surfactant)

The sizing agent may further contain a surfactant. By blending the surfactant in the sizing agent, the cellulose nanofiber is less likely to easily fall off from the inorganic fiber after the sizing agent is applied, that is, a falling prevention property of the cellulose nanofiber can be improved. Examples of the surfactant include an anionic surfactant, a cationic surfactant, a nonionic surfactant, and an amphoteric surfactant. These surfactants may be used singly or in combination of two or more kinds thereof.

As the nonionic surfactant, a known nonionic surfactant can be used as appropriate. Specific examples of the nonionic surfactant include (1) compounds in which an alkylene oxide with 2 to 4 carbon atoms is added to an organic acid, an organic alcohol, an organic amine, and/or an organic amide, for example, ether type nonionic surfactants, such as polyoxyethylene dilaurate, polyoxyethylene oleate, polyoxyethylene oleic acid diester, polyoxyethylene octyl ether, polyoxyethylene lauryl ether, polyoxyethylene lauryl ether methyl ether, polyoxyethylene polyoxypropylene lauryl ether, polyoxypropylene lauryl ether methyl ether, polyoxyethylene oleyl ether, polyoxybutylene oleyl ether, polyoxyethylene polyoxypropylene nonyl ether, polyoxypropylene nonyl ether, polyoxyethylene polyoxypropylene octyl ether, ethylene oxide adduct of 2-hexyl hexanol, polyoxyethylene 2-ethyl-1-hexyl ether, polyoxyethylene isononyl ether, polyoxyethylene dodecyl ether, compounds in which ethylene oxide is added to a secondary dodecyl alcohol, polyoxyethylene tridecyl ether, polyoxyalkylene tetradecyl ether, polyoxyethylene laurylamino ether, polyoxyethylene lauramide ether, and polyoxyalkylene tristyrenated phenyl ether, (2) polyoxyalkylene polyhydric alcohol fatty acid ester type nonionic surfactants, such as polyoxyalkylene sorbitan trioleate, polyoxyalkylene coconut oil, polyoxyalkylene castor oil, polyoxyalkylene hydrogenated castor oil, polyoxyalkylene hydrogenated castor oil triooctanoate, and maleic acid ester, stearic acid ester, or oleic acid ester of polyoxyalkylene hydrogenated castor oil, (3) alkyl amide type nonionic surfactants, such as stearic acid diethanolamide and diethanolamine monolauramide, (4) polyoxyalkylene fatty acid amide type nonionic surfactants, such as polyoxyethylene diethanolamine monooleylamide, polyoxyethylene laurylamine, and polyoxyethylene tallow amine, and (5) ether and ester compounds, such as copolymers of polyoxyethylene, dimethyl phthalate, and lauryl alcohol.

As the anionic surfactant, a known anionic surfactant can be used as appropriate. Specific examples of the anionic surfactant include (1) phosphoric acid ester salts of aliphatic alcohols, such as lauryl phosphoric acid ester salts, cetyl phosphoric acid ester salts, octyl phosphoric acid ester salts, oleyl phosphoric acid ester salts, and stearyl phosphoric acid ester salts, (2) phosphoric acid ester salts of adducts of at least one alkylene oxide selected from ethylene oxide and propylene oxide with an aliphatic alcohol, such as polyoxyethylene lauryl ether phosphoric acid ester salts, polyoxyethylene oleyl ether phosphoric acid ester salts, and polyoxyethylene stearyl ether phosphoric acid ester salts, (3) aliphatic sulfonic acid salts or aromatic sulfonic acid salts, such as lauryl sulfonic acid salts, myristyl sulfonic acid salts, cetyl sulfonic acid salts, oleyl sulfonic acid salts, stearyl sulfonic acid salts, tetradecane sulfonic acid salts, dodecylbenzene sulfonic acid salts, and secondary alkyl (C13 to C15) sulfonic acid salts, (4) sulfuric acid ester salts of aliphatic alcohols, such as lauryl sulfuric acid ester salts, oleyl sulfuric acid ester salts, and stearyl sulfuric acid ester salts, (5) sulfuric acid ester salts of adducts of at least one alkylene oxide selected from ethylene oxide and propylene oxide with an aliphatic alcohol, such as polyoxyethylene lauryl ether sulfuric acid ester salts, polyoxyalkylene (polyoxyethylene, polyoxypropylene) lauryl ether sulfuric acid ester salts, and polyoxyethylene oleyl ether sulfuric acid ester salts, (6) sulfuric acid ester salts of fatty acids, such as castor oil fatty acid sulfuric acid ester salts, sesame oil fatty acid sulfuric acid ester salts, tall oil fatty acid sulfuric acid ester salts, soybean oil fatty acid sulfuric acid ester salts, rapeseed oil fatty acid sulfuric acid ester salts, palm oil fatty acid sulfuric acid ester salts, lard fatty acid sulfuric acid ester salts, beef tallow fatty acid sulfuric acid ester salts, and whale oil fatty acid sulfuric acid ester salts, (7) sulfuric acid ester salts of oils and fats, such as sulfuric acid ester salts of castor oil, sulfuric acid ester salts of sesame oil, sulfuric acid ester salts of tall oil, sulfuric acid ester salts of soybean oil, sulfuric acid ester salts of rapeseed oil, sulfuric acid ester salts of palm oil, sulfuric acid ester salts of lard, sulfuric acid ester salts of beef tallow, and sulfuric acid ester salts of whale oil, (8) fatty acid salts, such as lauric acid salts, oleic acid salts, and stearic acid salts, and (9) sulfosuccinic acid ester salts of aliphatic alcohols, such as dioctyl sulfosuccinic acid salts. Examples of a counterion of the anionic surfactant include alkali metal salts, such as a potassium salt and a sodium salt, an ammonium salt, and alkanolamine salts, such as triethanolamine.

As the cationic surfactant, a known cationic surfactant can be used as appropriate. Specific examples of the cationic surfactant include lauryltrimethylammonium chloride, cetyltrimethylammonium chloride, stearyltrimethylammonium chloride, behenyltrimethylammonium chloride, didecyldimethylammonium chloride, 1,2-dimethylimidazole, and triethanolamine.

As the amphoteric surfactant, a known amphoteric surfactant can be used as appropriate. Specific examples of the amphoteric surfactant include a betaine amphoteric surfactant.

The lower limit of the content ratio of the surfactant in the nonvolatile content of the sizing agent is preferably 1% by mass or more, and more preferably 2% by mass or more. When the content ratio is 1% by mass or more, the falling prevention property can be further improved. The upper limit of the content ratio of the surfactant is preferably 50% by mass or less, and more preferably 40% by mass or less. When the content ratio is 50% by mass or less, adhesiveness can be further improved.

The action and effect of the sizing agent of the present embodiment will be described.

(1-1) The sizing agent of the present embodiment contains a predetermined amount of cellulose nanofibers and a resin. When the sizing agent is attached to an inorganic fiber, adhesiveness of the inorganic fiber to a base material of the composite material and falling prevention property of a cellulose nanofiber from the inorganic fiber can be improved. In particular, when the sizing agent is directly applied to the inorganic fiber surface, irregularities derived from cellulose nanofibers are formed on the fiber surface, so that the adhesiveness is improved by the anchor effect. In addition, when the matrix resin is impregnated with the inorganic fiber to which the sizing agent is attached to form a composite material, expansion of cracks at the interface between the inorganic fiber and the matrix resin is suppressed, so that strength of the composite material can be improved.

(1-2) The content ratio of the cellulose nanofibers in the nonvolatile content of the sizing agent is less than 50000 ppm. Therefore, fluidity of a solution of the sizing agent can be improved or decrease in fluidity can be suppressed. In addition, when the sizing agent is diluted with a solvent or when the sizing agent is prepared, the sizing agent can be easily mixed with the solvent. Therefore, the handling property of the sizing agent can be improved.

### Second Embodiment

Next, a second embodiment in which a method for producing an inorganic fiber according to the present invention is embodied will be described. The second embodiment is the same as the first embodiment except for the following matters.

The method for producing an inorganic fiber of the present embodiment includes attaching the sizing agent of the first embodiment to a carbon fiber. The attached amount (not containing a solvent) is not particularly limited, but the sizing agent is preferably attached to the inorganic fiber in an amount of 0.01% by mass or more and 10% by mass or less. By defining the attached amount in such a numerical range, the effect such as a bundling property of the inorganic fibers can be further improved.

### (Inorganic Fiber)

The type of the inorganic fiber applied in the present embodiment is not particularly limited, and examples thereof include a glass fiber, a carbon fiber, a ceramic fiber, a metal fiber, a mineral fiber, a rock fiber, and a slug fiber. Among them, a glass fiber and a carbon fiber are preferable from the viewpoint of more effectively exhibiting the effects of the present invention. Examples of the type of a carbon fiber include PAN-based carbon fibers obtained from acrylic fibers as a raw material, pitch-based carbon fibers obtained from pitch as a raw material, and carbon fibers obtained from recycled carbon fibers, polyester fibers, polyethylene resins, phenol resins, cellulose resins, or lignin resins as raw materials.

In order to attach the sizing agent of the first embodiment to the inorganic fiber, a method generally used industrially can be used. Examples thereof include a roller immersion method, a roller contact method, a spray method, and a papermaking method. The inorganic fiber to which the sizing agent is attached may be subsequently subjected to a drying treatment using a known method.

According to the method for producing an inorganic fiber of the present embodiment, the following effects can be obtained in addition to the effects of the first embodiment.

(2-1) The method for producing an inorganic fiber of the present embodiment includes attaching a sizing agent containing cellulose nanofibers and a resin to a carbon fiber. Therefore, in particular, the falling prevention property of the cellulose nanofiber from the inorganic fiber can be improved. In addition, since the application of the sizing agent to the inorganic fiber is completed in a single step, it is efficient, that is, process efficiency can also be improved.

### Third Embodiment

Next, a third embodiment in which a composite material according to the present invention is embodied will be described. The third embodiment is the same as the first and second embodiments except for the following matters.

The composite material is obtained by impregnating a matrix resin as a base material with the inorganic fiber to which the sizing agent is attached according to the second embodiment. The form of the inorganic fiber in producing the composite material is not particularly limited, and for example, a long fiber form, a short fiber form, a nonwoven fabric form can be adopted.

### (Matrix Resin)

The matrix resin is appropriately selected from known ones according to, for example, the purpose and use of the composite material. Specific examples of the matrix resin include an epoxy resin, a vinyl ester resin, a polyamide resin, a polyolefin resin, a polyurethane resin, a polycarbonate resin, a polyester resin, a PEEK resin, a fluororesin, a phenoxy resin, a phenol resin, a BMI resin, a polyimide resin, a polyimide resin precursor, and a polyethersulfone resin.

The matrix resin may be selected in consideration of the type of resin contained in the sizing agent from the viewpoint of, for example, improving adhesiveness to the inorganic fiber and improving recyclability. When the matrix resin is an epoxy resin, the resin in the sizing agent is preferably at least one selected from an epoxy resin and a polyester resin. When the matrix resin is a polyamide resin, the resin in the sizing agent is preferably at least one selected from a polyamide resin, a polyurethane resin, a polyimide resin, and a polyimide resin precursor. When the matrix resin is a vinyl ester resin, the resin in the sizing agent is preferably a vinyl ester resin. When the matrix resin is a polyolefin resin, the resin in the sizing agent is preferably at least one selected from a polyolefin resin and a phenoxy resin.

According to the composite material of the present embodiment, the following effects can be obtained.

(3-1) A sizing agent containing a predetermined amount of cellulose nanofibers and a resin is previously attached to the inorganic fibers contained in the composite material of the present embodiment. Therefore, a fiber-reinforced resin composite material excellent in various properties such as mechanical properties in particular is obtained due to excellent adhesiveness between the inorganic fibers and the matrix resin.

The above embodiments may be modified as follows. The above embodiments and the following modification examples can be implemented in combination with each other within a range not technically contradictory.
From the viewpoint of, for example, maintaining performance of the sizing agent, improving an application property to the inorganic fiber, the sizing agent of the above embodiments does not hinder blending of water or an organic solvent, a smoothing agent, an antioxidant, a preservative, and the like as other components within the range in which the effects of the present invention is not impaired.
The field to which the sizing agent of the above embodiments is applied is not particularly limited. For example, the sizing agent of the above embodiments may be applied to a carbon fiber composite material (CFRP) impregnated with a matrix resin, such as a polyimide resin, or a reinforcing fiber for concrete.

### Examples

Examples will now be given below in order to describe the features and effects of the present invention more specifically, but the present invention is not limited to these examples.

### Experimental Part 1 (Preparation of Sizing Agent)

In the preparation of the sizing agent of Example 1, cellulose nanofibers (A-1) with a fiber diameter (minimum-maximum) of 20-300 nm and a fiber diameter (average) of 180 nm shown in Table 1, epoxy resins (B-1) shown in Table 2 as resin (B), and random adducts (C-1) of 30 mol of ethylene oxide and 5 mol of propylene oxide of tristyrenated phenol (C-1) shown in Table 3 as surfactant (C) were used as raw materials. Then, a resin emulsion prepared in advance, an aqueous dispersion of cellulose nanofibers prepared in advance, and a surfactant were mixed to obtain an aqueous solution of the sizing agent of Example 1 having the content ratio shown in Table 4.

In the preparation of sizing agents of Examples 2 to 15 and Comparative Example 1 to 5, cellulose nanofiber (A) in Table 1, resin (B) in Table 2, and if necessary, surfactant (C) in Table 3 were used as raw materials. Then, aqueous solutions of a sizing agent were obtained by a preparation method shown in any one of the following A to E.

A: A mixture of the respective raw materials was heated to 100° C. and made uniform, and then cooled to 70° C. or lower, and water was gradually added thereto to obtain an aqueous solution of a sizing agent.

B: A resin emulsion containing a surfactant prepared in advance and an aqueous dispersion of cellulose nanofibers prepared in advance were mixed to obtain an aqueous solution of a sizing agent.

C: A resin emulsion prepared in advance, an aqueous dispersion of cellulose nanofibers prepared in advance, and a surfactant were mixed to obtain an aqueous solution of a sizing agent.

D: A resin emulsion prepared in advance and an aqueous dispersion of cellulose nanofibers prepared in advance were mixed to obtain an aqueous solution of a sizing agent.

E: An aqueous solution of a sizing agent was obtained using a resin emulsion prepared in advance.

The type and content of cellulose nanofiber (A) contained in the aqueous solutions of the sizing agents thus obtained, the type and content of resin (B) as a nonvolatile content, the type and content of surfactant (C), and the method for preparing the sizing agent are shown in the column of “Cellulose nanofiber (A),” the column of “Resin (B),” the column of “Surfactant (C),” and the column of “Mixing method at production” of Table 4, respectively. The nonvolatile content of the resin (B) was determined as the mass of absolutely dry matter from which volatile substances were sufficiently removed by heat-treating an object at 105° C. for 2 hours.

TABLE 1

| | Fiber diameter | Fiber diameter |
|---|---|---|
| Division | (minimum-maximum) [nm] | (average) [nm] |
| A-1 | 20-300 | 180 |
| A-2 | 100-500 | 250 |
| A-3 | 50-300 | 200 |
| A-4 | 30-200 | 90 |
| A-5 | 3-4 | 3.5 |
| A-6 | 3-4 | 3.3 |

TABLE 2

| | | Solid |
|---|---|---|
| Division | Resin | content |
| B-1 | Epoxy resin, manufactured by Mitsubishi Chemical | 100% |
| | Corporation, trade name: jER828 | |
| B-2 | Epoxy resin, manufactured by Mitsubishi Chemical | 100% |
| | Corporation, trade name: jER1002 | |
| B-3 | Polyurethane resin, manufactured by DKS Co. Ltd., | 45% |
| | trade name: SUPERFLEX 500M | |
| B-4 | Modified polypropylene resin, manufactured by | 30% |
| | Maruyoshi Chemical Co., Ltd., trade name: | |
| | MGP-1650 | |
| B-5 | Modified polypropylene resin, manufactured by | 35% |
| | TOHO Chemical Industry Co., Ltd., trade name: | |
| | Hitech P-9018 | |
| B-6 | Modified polyester resin, manufactured by Toyobo | 25% |
| | Co., Ltd., trade name: Vylonal MD-1480 | |
| B-7 | Phenoxy resin, manufactured by Nippon Steel | 100% |
| | Chemical & Materials Co., Ltd., trade name: | |
| | YP-50S | |
| B-8 | Polyimide resin precursor of 3,3′,4,4′-biphenyl- | 10% |
| | tetracarboxylic anhydride and diaminodiphenyl ether | |
| B-9 | Polyamide resin, manufactured by Toray Industries, | 50% |
| | Inc., trade name: AQ Nylon P-95 | |
| B-10 | Polyester resin of EO 2 mol adduct of bisphenol A | 100% |
| | and fumaric acid | |
| B-11 | Vinyl ester resin of epoxy resin and methacrylic acid | 100% |
| B-12 | Epoxy resin, manufactured by Nagase ChemteX | 100% |
| | Corporation, trade name: Denacol EX-521 | |

TABLE 3

| Division | Surfactant |
|---|---|
| C-1 | Random adduct of 30 mol of ethylene oxide and 5 mol of |
| | propylene oxide of tristyrenated phenol |
| C-2 | Compound obtained by adding 10 mol of ethylene oxide to |
| | dodecyl alcohol |
| C-3 | Compound obtained by adding 15 mol of ethylene oxide to |
| | isononyl alcohol |
| C-4 | Compound obtained by adding 10 mol of ethylene oxide and |
| | 5 mol of propylene oxide to tetradecyl alcohol |
| C-5 | Compound obtained by adding 7 mol of ethylene oxide to |
| | secondary dodecyl alcohol |
| C-6 | Sodium dodecylbenzenesulfonate |
| C-7 | 1,2-Dimethylimidazole |
| C-8 | Triethanolamine |
| C-9 | Copolymer of polyethylene glycol with average molecular |
| | weight of 2000, dimethyl terephthalate, and lauryl |
| | alcohol |

TABLE 4

| | Sizing agent for inorganic fibers | | | | | | | | |
|---|---|---|---|---|---|---|---|---|---|
| | | | | | Cellulose nanofiber (A) | | | | |
| | | | | | | | Content in | | Inorganic fiber |
| | Resin (B) | | Surfactant (C) | | | | nonvolatile | Mixing | used for |
| | | Parts by | | Parts by | | Parts by | content | method at | adhesiveness |
| | Type | mass *1) | Type | mass | Type | mass *2) | (ppm) *3) | production | evaluation |
| Example 1 | B-1 | 70 | C-1 | 30 | A-1 | 0.07 | 700 | B | Carbon fiber |
| Example 2 | B-1 | 40 | C-1 | 25 | A-2 | 0.30 | 2991 | A | Carbon fiber |
| | B-2 | 35 | | | | | | | |
| Example 3 | B-3 | 95 | C-2 | 5 | A-3 | 0.19 | 1896 | C | Carbon fiber |
| Example 4 | B-1 | 45 | C-1 | 10 | A-4 | 0.0595 | 595 | B | Carbon fiber |
| | B-3 | 40 | C-3 | 5 | | | | | |
| Example 5 | B-4 | 98 | C-4 | 2 | A-5 | 0.1470 | 1468 | C | Carbon fiber |
| Example 6 | B-5 | 98 | C-6 | 2 | A-6 | 0.0784 | 783 | C | Glass fiber |
| Example 7 | B-6 | 95 | C-5 | 5 | A-5 | 0.095 | 949 | C | Carbon fiber |
| Example 8 | B-1 | 40 | C-1 | 50 | A-4 | 0.025 | 250 | B | Carbon fiber |
| | B-7 | 10 | | | A-6 | 0.050 | 500 | | |
| Example 9 | B-8 | 60 | C-7 | 40 | A-3 | 0.30 | 2991 | B | Carbon fiber |
| Example 10 | B-9 | 95 | C-8 | 5 | A-4 | 2.85 | 27710 | C | Carbon fiber |
| Example 11 | B-1 | 30 | C-1 | 28 | A-5 | 0.175 | 1747 | B | Carbon fiber |
| | B-10 | 40 | C-9 | 2 | | | | | |
| Example 12 | B-11 | 60 | C-1 | 40 | A-1 | 0.024 | 240 | B | Glass fiber |
| Example 13 | B-1 | 20 | C-1 | 40 | A-2 | 0.0018 | 18 | A | Glass fiber |
| | B-10 | 40 | | | | | | | |
| Example 14 | B-11 | 60 | C-1 | 40 | A-1 | 4.82 | 45904 | B | Glass fiber |
| Example 15 | B-4 | 100 | — | — | A-5 | 0.0091 | 91 | D | Carbon fiber |
| Comparative | B-12 | 100 | — | — | A-1 | 40.0 | 285714 | D | Carbon fiber |
| Example 1 | | | | | | | | | |
| Comparative | B-6 | 100 | — | — | — | — | — | E | Carbon fiber |
| Example 2 | | | | | | | | | |
| Comparative | B-3 | 100 | — | — | — | — | — | E | Glass fiber |
| Example 3 | | | | | | | | | |
| Comparative | B-4 | 95 | C-3 | 5 | A-2 | 0.0005 | 5 | C | Carbon fiber |
| Example 4 | | | | | | | | | |
| Comparative | B-1 | 40 | C-1 | 25 | A-2 | 5.8 | 54820 | A | Carbon fiber |
| Example 5 | B-2 | 35 | | | | | | | |

| | Matrix resin | Evaluation | | | |
|---|---|---|---|---|---|
| | used for | | Falling | | |
| | adhesiveness | | prevention | Handling | Process |
| | evaluation | Adhesiveness | property | property | efficiency |
| Example 1 | Epoxy resin | ◯ | ⊚ | ◯ | ◯ |
| Example 2 | Epoxy resin | ◯ | ⊚ | ◯ | ◯ |
| Example 3 | Polyamide resin | ◯ | ⊚ | ◯ | ◯ |
| Example 4 | Epoxy resin | ◯ | ⊚ | ◯ | ◯ |
| Example 5 | Polypropylene | ◯ | ⊚ | ◯ | ◯ |
| | resin | | | | |
| Example 6 | Polypropylene | ◯ | ⊚ | ◯ | ◯ |
| | resin | | | | |
| Example 7 | Epoxy resin | ◯ | ⊚ | ◯ | ◯ |
| Example 8 | Epoxy resin | ◯ | ⊚ | ◯ | ◯ |
| Example 9 | Polyamide resin | ◯ | ⊚ | ◯ | ◯ |
| Example 10 | Polyamide resin | ◯ | ⊚ | ◯ | ◯ |
| Example 11 | Epoxy resin | ◯ | ⊚ | ◯ | ◯ |
| Example 12 | Vinyl ester resin | ◯ | ⊚ | ◯ | ◯ |
| Example 13 | Epoxy resin | ◯ | ⊚ | ◯ | ◯ |
| Example 14 | Vinyl ester resin | ◯ | ⊚ | ◯ | ◯ |
| Example 15 | Polypropylene | ◯ | ◯ | ◯ | ◯ |
| | resin | | | | |
| Comparative | Epoxy resin | ◯ | X | X | ◯ |
| Example 1 | | | | | |
| Comparative | Epoxy resin | X | — | ◯ | ◯ |
| Example 2 | | | | | |
| Comparative | Polyamide resin | X | — | ◯ | ◯ |
| Example 3 | | | | | |
| Comparative | Polypropylene | X | ⊚ | ◯ | ◯ |
| Example 4 | resin | | | | |
| Comparative | Epoxy resin | ◯ | ⊚ | X | ◯ |
| Example 5 | | | | | |

Details of the resins described in the column of “Matrix resin used for adhesiveness evaluation” in Table 4 and meanings represented by “*1),” “*2),” and “*3)” in Table 4 are as follows.

### (Matrix Resin Used for Adhesiveness Evaluation)

Epoxy resin: trade name jER828 manufactured by Mitsubishi Chemical Corporation+triethylenetetramine
Vinyl ester resin: trade name Lipoxy R-804B manufactured by Showa Denko K.K. (using a methyl ethyl ketone peroxide curing agent manufactured by the same company)
Polyamide resin: UBE nylon 1011FB manufactured by UBE Industries Ltd.
Polypropylene resin: 2% by mass maleic anhydride-modified polypropylene
*1): Nonvolatile content standard
*2): Parts by mass with respect to 100 parts by mass of the total of the nonvolatile content of resin (B) and surfactant (C)
*3): Content ratio in the nonvolatile content of the sizing agent (ppm)

### Experimental Part 2 (Evaluation)

### Evaluation of Adhesiveness

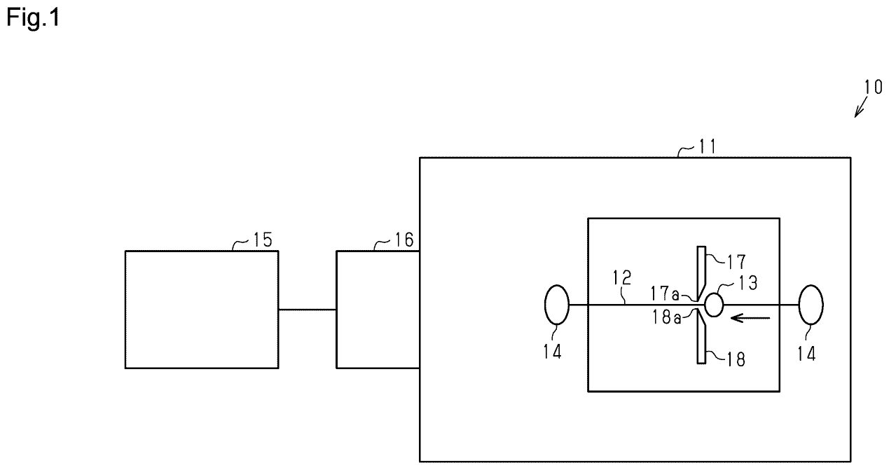

Adhesiveness was evaluated by stress measured by a microdroplet method using a commercially available composite material interface characteristic evaluation apparatus. FIG. 1 shows a schematic view of the composite material interface characteristic evaluation apparatus 10.

The aqueous solution of each example prepared as described above was further diluted with water to prepare an aqueous solution having a solid content of 2% by mass. The aqueous solution was supplied by an immersion method so as to be applied in an amount of 2% by mass as a solid content to strand carbon fibers or glass fibers, thereby preparing strand carbon fibers or glass fibers to which the sizing agent of each example was applied.

Next, one carbon fiber or glass fiber was taken out from the strand carbon fibers or glass fibers, and both ends of this fiber 12 were fixed to a plate-like square frame holder 11 with an adhesive 14 under tension. Next, the matrix resin of each example shown in Table 4 was attached to the fiber 12 so as to be a resin droplet 13 with a diameter of approximately 70 μm, and fixed.

Two plate-like blades 17 and 18, each of whose vertical cross section has been molded in a tapered shape on one side surface, are attached to an apparatus body (not illustrated) in a state where tip portions 17a and 18a thereof face each other.

The holder 11 was attached to a substrate 16 fixed to the apparatus body at a position where the fiber 12 to which the resin droplet 13 was fixed was sandwiched between the tip portions 17a and 18a of the two blades 17 and 18. A load cell 15 is connected to the substrate 16, and a stress applied to the substrate 16 is measured.

When the holder 11 was moved in the fiber axis direction at a speed of 5 mm/min, maximum stress F generated when the resin droplet 13 was peeled off from the fiber 12 by the tip portions 17a and 18a of the blades 17 and 18 was measured by the load cell 15.

Using the measured values, the interface shear strength t was calculated by the following formula 1. The same operation was carried out 20 times, and the average value of the obtained interfacial shear strength was obtained. Further, regarding the obtained average value, an increase rate with respect to the reference numerical value of the used matrix resin shown below was obtained, and evaluation was performed according to the following criteria. The results are shown in “Adhesiveness” in Table 4. The type of inorganic fiber and the type of matrix resin used are shown in the column of “Inorganic fiber used for adhesiveness evaluation” and the column of “Matrix resin used for adhesiveness evaluation” in Table 4, respectively.

$$τ = F / π DL \qquad [ Mathematical formula 1 ]$$

In formula 1,
F is a maximum stress (N) generated when the resin droplet 13 is peeled off from the fiber 12,
D is a diameter of the fiber 12 (m), and
L is a diameter (m) in the drawing direction of the resin droplet 13.
Reference numerical values of the matrix resins used
Epoxy resin: 60 MPa
Vinyl ester resin: 40 MPa
Polyamide resin: 50 MPa
Polypropylene resin: 22 MPa
Evaluation criteria of adhesiveness
∘ (acceptable): Increase rate is 5% or more.
× (poor): Increase rate is less than 5%.

### Evaluation of Falling Prevention Property

The presence or absence of falling off of the cellulose nanofiber from the inorganic fiber after passing through a sizing bath for applying a sizing agent to the inorganic fiber was confirmed at a metal roller portion after the drying step, and the falling prevention property was evaluated according to the following criteria. The results are shown in the column of “Falling prevention property” in Table 4.
⊚ (good): The falling off of the cellulose nanofiber was not observed on the metal roller, and continuous operation for two weeks or more was possible.
∘ (acceptable): The falling off of the cellulose nanofiber was slightly observed on the metal roller, but continuous operation for two weeks or more was possible.
× (poor): The falling off of the cellulose nanofiber was frequently observed on the metal roller, and it was necessary to stop the production and clean the metal roller in less than two weeks.

### Handling Property

The handling property of the sizing agent of each example was evaluated according to the following criteria. The results are shown in the column of “Handling property” in Table 4.
∘ (acceptable): When used as a one-component sizing agent in a process for producing inorganic fibers, the sizing agent maintained fluidity, so that it was easy to measure the weight and feed the sizing agent into the process by a pump.
× (poor): When used as a one-component sizing agent in a process for producing inorganic fibers, the sizing agent did not maintain fluidity, so that it was difficult to measure the weight and feed the sizing agent into the process by a pump.

### Evaluation of Process Efficiency

The process efficiency of the sizing agent of each example was evaluated according to the following criteria. The results are shown in the column of “Process efficiency” in Table 4.
∘ (acceptable): Application of the cellulose nanofibers and the resin to the fiber is completed in one step.
× (poor): There is a two-step process of applying the cellulose nanofibers to the fiber and then applying the sizing agent containing the resin to the fiber.

As is apparent from the results of Table 4 above, the sizing agents of the respective Examples were evaluated in terms of the adhesiveness, the falling prevention property, the handling property, and the process efficiency, all of which were acceptable or more. According to the present invention, an effect of being able to improve adhesiveness, a falling prevention property, a handling property, and process efficiency is produced.

### REFERENCE SIGNS LIST

10 . . . Composite material interface characteristic evaluation apparatus
11 . . . Holder
12 . . . Fiber
13 . . . Resin droplet
14 . . . Adhesive
15 . . . Load cell
16 . . . Substrate
17, 18 . . . Blade

1. An inorganic fiber sizing agent comprising a resin and cellulose nanofibers, wherein the cellulose nanofibers are contained in a nonvolatile content of the sizing agent in an amount of 10 ppm or more and less than 50000 ppm.

2. The inorganic fiber sizing agent according to claim 1, wherein the cellulose nanofibers contain cellulose nanofibers with a fiber diameter of 1 nm or more and 1000 nm or less.

3. The inorganic fiber sizing agent according to claim 1, wherein the resin contains at least one selected from the group consisting of an epoxy resin, a vinyl ester resin, a polyamide resin, a polyolefin resin, a polyurethane resin, a polyester resin, a phenoxy resin, a polyimide resin, and a polyimide resin precursor.

4. The inorganic fiber sizing agent according to claim 1, further comprising a surfactant.

5. The inorganic fiber sizing agent according to claim 1, wherein the inorganic fiber sizing agent is applied to a glass fiber or a carbon fiber.

6. The inorganic fiber sizing agent according to claim 1, wherein the resin contains at least one selected from the group consisting of an epoxy resin and a polyester resin, and the inorganic fiber sizing agent is applied to a composite material in which a matrix resin is an epoxy resin.

7. The inorganic fiber sizing agent according to claim 1, wherein the resin contains at least one selected from the group consisting of a polyamide resin, a polyurethane resin, a polyimide resin, and a polyimide resin precursor, and the inorganic fiber sizing agent is applied to a composite material in which a matrix resin is a polyamide resin.

8. The inorganic fiber sizing agent according to claim 1, wherein the resin contains a vinyl ester resin, and the inorganic fiber sizing agent is applied to a composite material in which a matrix resin is a vinyl ester resin.

9. The inorganic fiber sizing agent according to claim 1, wherein the resin contains at least one selected from the group consisting of a polyolefin resin and a phenoxy resin, and the inorganic fiber sizing agent is applied to a composite material in which a matrix resin is a polyolefin resin.

10. An inorganic fiber having the inorganic fiber sizing agent according to claim 1 attached thereto.

11. A method for producing an inorganic fiber, comprising attaching the inorganic fiber sizing agent according to claim 1 to an inorganic fiber.

12. A composite material comprising the inorganic fiber according to claim 10 and a matrix resin, wherein the resin in the inorganic fiber sizing agent contains at least one selected from the group consisting of an epoxy resin and a polyester resin, and the matrix resin is an epoxy resin.

13. A composite material comprising the inorganic fiber according to claim 10 and a matrix resin, wherein the resin in the inorganic fiber sizing agent contains at least one selected from the group consisting of a polyamide resin, a polyurethane resin, a polyimide resin, and a polyimide resin precursor, and the matrix resin is a polyamide resin.

14. A composite material comprising the inorganic fiber according to claim 10 and a matrix resin, wherein the resin in the inorganic fiber sizing agent contains a vinyl ester resin, and the matrix resin is a vinyl ester resin.

15. A composite material comprising the inorganic fiber according to claim 10 and a matrix resin, wherein the resin in the inorganic fiber sizing agent contains at least one selected from the group consisting of a polyolefin resin and a phenoxy resin, and the matrix resin is a polyolefin resin.
